(19) United States
(12) Patent Application Publication
(10) Pub. No.: US 2010/0332874 A1
(43) Pub. Date: Dec. 30, 2010

(54) MICROCOMPUTER AND MICROCOMPUTER SYSTEM

(75) Inventor: Yosuke ITABASHI, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/791,715

(22) Filed: Jun. 1, 2010

(30) Foreign Application Priority Data
Jun. 29, 2009 (JP) 2009-153966

(51) Int. Cl. G06F 1/00

(52) U.S. Cl. 713/322; 713/324

(57) ABSTRACT

A microcomputer includes a CPU, a standby controller that controls setting of and recovering from a sleep mode of the CPU, an output terminal, a first timer, an output terminal controller, and a second timer. When the first timer performs predetermined time measurement when the CPU is in the sleep mode, the output terminal controller changes the level of the output terminal while maintaining the sleep mode. The second timer starts time measurement when the output terminal controller changes the level of the output terminal in the sleep mode. The standby controller performs recovering from the sleep mode of the CPU when the second timer performs a prescribed time measurement.

### REFERENCE TO RELATED APPLICATION

This application is based upon and claims the benefit of the priority of Japanese patent application No. 2009-153966, filed on Jun. 29, 2009, the disclosure of which is incorporated herein in its entirety by reference thereto.

### TECHNICAL FIELD

The present invention relates to a microcomputer and a microcomputer system. In particular, the invention relates to a microcomputer that can change the level of an output terminal, in a sleep mode in which CPU operation is inactive, and to a microcomputer system using such a microcomputer.

### BACKGROUND

With regard to an in-vehicle application controlled by a microcomputer, such as a keyless entry system, for example, a microcomputer system is known which intermittently operates a microcomputer and an external device controlled by the microcomputer. This is in order to control power consumption of the system, by stopping a system clock or the like, when operation is unnecessary.

In recent years, there has been an increase in systems that perform functional diagnosis of an overall system when intermittent operation starts. In the intermittent operation in particular, lower power consumption of systems is sought by shortening wake-up time as much as possible. As a method of controlling time management of the intermittent operation by the microcomputer, a method is known in which a specific input-output port value is changed and used in a wake-up signal for an external device, by a timer circuit built into the microcomputer.

FIG. 4 is a block diagram of an overall conventional microcomputer described in FIG. 25 of Patent Document 1. The microcomputer 101 is provided with a CPU 102 in a central role, and, as peripherals thereof, a main oscillator circuit 103, a clock control circuit 104, a CR oscillator circuit 105, a port control circuit (signal level change means) 106, and the like. The main oscillator circuit 103 supplies a clock signal (machine clock or system clock) for operation to the CPU 102 by making a crystal oscillator 107, which is connected to outside the microcomputer 101, oscillate.

The clock control circuit 104 receives a wake-up signal WKUP outputted in response to an occurrence of a wake-up factor, stops output of a clock stop signal, and restarts output of the clock signal by the main oscillator circuit 103. The port control circuit 106 is a circuit that performs level control of an output terminal (external signal output terminal) 110 of the microcomputer 101, in accordance with a setting performed by the CPU 102 in an internal register.

FIG. 5 is a functional block diagram showing an internal configuration of the conventional port control circuit 106 described in FIG. 26 of Patent Document 1. A timer (level change timer) 111 performs a count operation based on a CR clock signal outputted by the CR oscillator circuit 105 of FIG. 4. Count data thereof is given to a comparator (comparator circuit) 112. With regard to the timer 111, in a case where a SLEEP signal is active, a count operation is enabled. Setting data of an output timing register 113 is also given to the comparator 112, and when data values of both match, the comparator 112 outputs a match signal to a level setting unit 115 via a match holding unit 114. With the match signal given via the match holding unit 114 as a trigger, the level setting unit 115 outputs a signal of a level set in a level selection unit 116 to an output terminal 110 of the microcomputer 101. By the CPU 102 of FIG. 4 performing writing to a reset register provided separately, an output state of the match holding unit 114 is configured such that resetting (S/W resetting) is possible.

FIG. 6 is a timing chart during sleep mode transition described in FIG. 28 of Patent Document 1. When a SLEEP signal becomes active (high) (e), a machine clock outputted by the main oscillator circuit 103 is stopped (d). The timer 111 of the port control circuit 106 starts a count operation from the SLEEP signal rising (b). Pre-set data is set in the output timing register 113 (a), and when a count value of the timer 111 reaches the set data, the comparator 112 outputs a match signal. Then, at this point in time, the level setting unit 115 changes a signal level of the output terminal 110 from L (low) to H (high). Here, by the signal level of the output terminal 110 changing to high, an external device connected to the output terminal 110 goes into an active state. Thereafter, a set sleep duration period passes and the CPU 102 wakes up. As described above, a configuration is known in which the port control circuit 106 of the microcomputer 101 in a conventional example changes the level of the output terminal 110 within a period in which the CPU 102 is set to a sleep mode.

Furthermore, FIG. 7, in a functional block diagram of another conventional microcomputer described in FIG. 9 of Patent Document 1, describes a CPU being woken up by a restart timer 36 when a sleep duration period has passed.

[Patent Document 1] JP Patent Kokai Publication No. JP-P2008-123538A

### SUMMARY

The entire disclosure of Patent Document 1 is incorporated herein by reference thereto. The following analysis is given by the present invention. In Patent Document 1 shown in the abovementioned FIG. 5 and FIG. 7, as a method of waking up a microcomputer from a sleep mode, use is made of the restart timer 36 that periodically performs recovering from the sleep mode at pre-set timing. However, in a case where for some reason a delay occurs in processing during normal operation before a sleep mode transfer, since a deviation from expected CPU wake-up timing occurs in the re-start timer 36, the CPU cannot wake up at the expected timing.

A microcomputer according to a first aspect of the present invention is provided with: a CPU, a standby controller that controls setting of and recovering from a sleep mode of the CPU, an output terminal, a first timer, an output terminal controller that, when the first timer performs predetermined time measurement when the CPU is in the sleep mode, changes the level of the output terminal while maintaining the sleep mode, and a second timer that starts time measurement when the output terminal controller changes the level of the output terminal in the sleep mode, wherein the standby controller performs recovering from the sleep mode of the CPU when the second timer performs a prescribed time measurement.

Furthermore, a microcomputer system according to a second aspect of the present invention includes a microcomputer and an external device controlled by the microcomputer, the microcomputer and the external device each having a normal operation mode and a sleep mode with lower power consumption than the normal operation mode, wherein the microcomputer is provided with: an output terminal that controls the modes of the external device, a first timer that, when both of the microcomputer and the external device are in sleep mode, measures time to wake up the external device, an output terminal control circuit that, when the first timer has measured the wake-up time of the external device, changes the level of the output terminal to wake up the external device, while maintaining the sleep mode of the microcomputer, and a second timer that, when the first timer measures time for wake-up of the external device, starts a count, measures wake-up time of the microcomputer, and when wake-up time of the microcomputer has come, performs recovering the micro computer from the sleep mode to return to the normal operation mode.

The meritorious effects of the present invention are summarized as follows. According to the present invention, since time until the level of an output terminal during sleep mode is changed, is measured by a first timer, and time from the level of the output terminal being changed until a CPU is recovered from the sleep mode, is measured by a second timer, timing of recovering from the sleep mode is made preferable, and there is no wasted power consumption.

### BRIEF DESCRIPTIONS OF THE DRAWINGS

FIG. 1 is a block diagram of an overall microcomputer system according to an example of the present invention.

FIG. 2 is a block diagram of a timer vicinity in a microcomputer in an example.

FIG. 3 is a timing diagram of sleep mode control in the microcomputer system according to an example of preferred mode and a comparative example.

FIG. 4 is an overall block diagram of a conventional microcomputer.

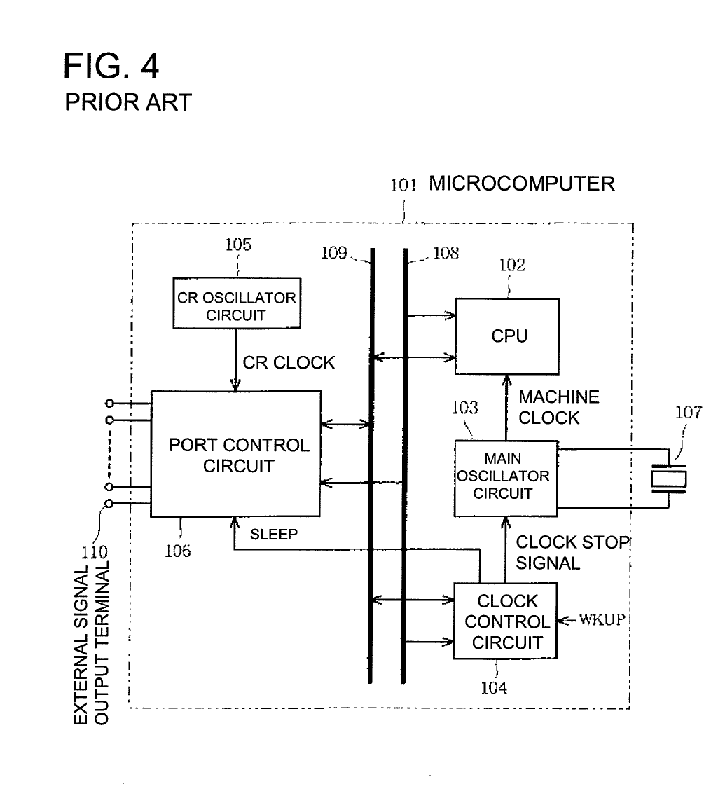

FIG. 5 is a functional block diagram showing an internal configuration of a port control circuit in a conventional microcomputer.

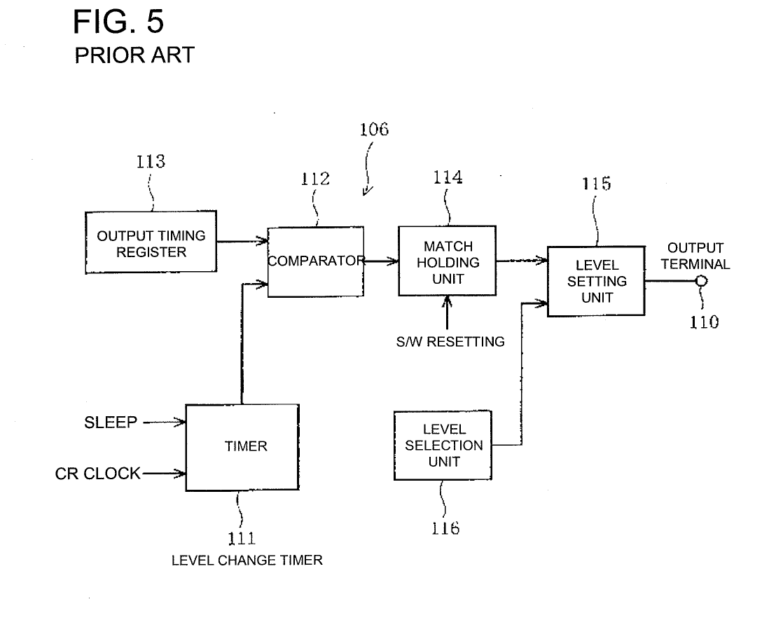

FIG. 6 is a timing diagram of standby control in a conventional microcomputer.

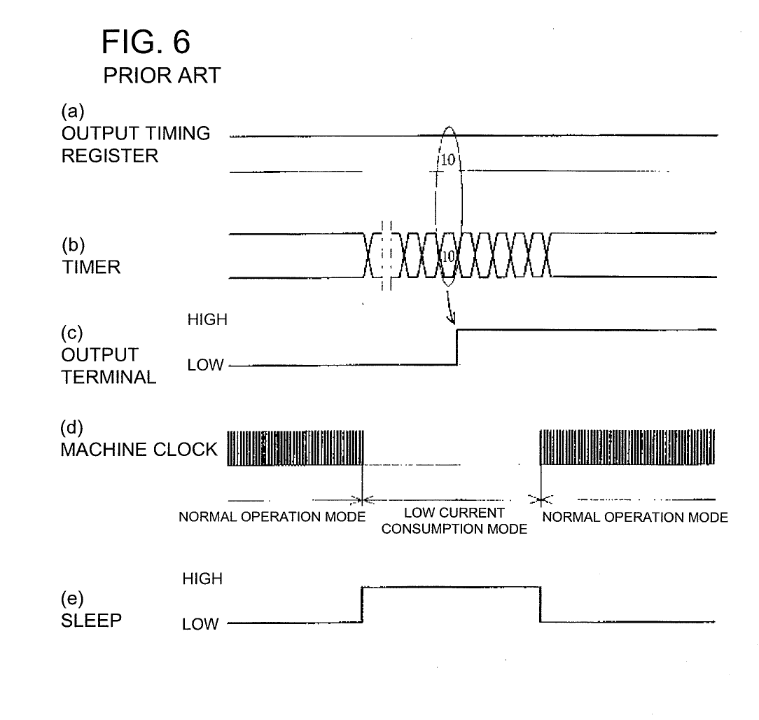

FIG. 7 is a block diagram of a low power consumption controller vicinity in a conventional microcomputer.

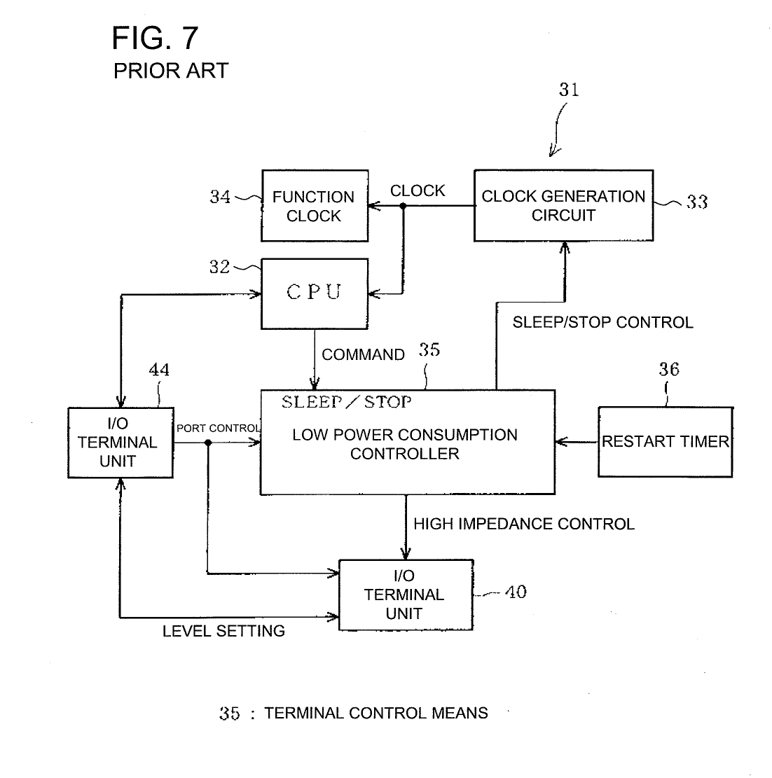

### PREFERRED MODES

Before describing a specific example, a description is given concerning an outline of preferred modes of the present invention. In the description of the outline, drawings and reference symbols of the drawings are indicative of one example of preferred modes, and are not intended to thereby limit variations of the preferred modes according to the present invention.

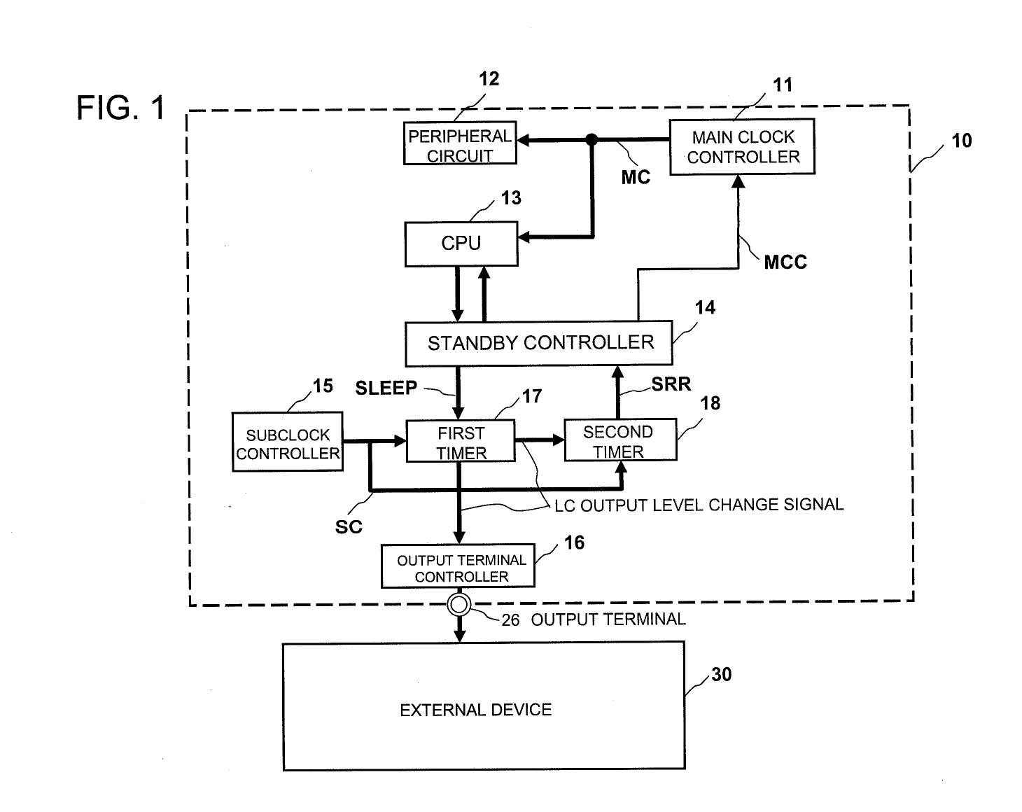

A microcomputer 10 in one exemplary embodiment of the present invention, as shown in FIG. 1, for example, is provided with a CPU 13, a standby controller 14 that controls setting of and recovering from a sleep mode of the CPU 13, an output terminal 26, a first timer 17, an output terminal controller 16 that, when the first timer 17 performs predetermined time measurement when the CPU 13 is in sleep mode, changes level of the output terminal 26 while maintaining the sleep mode, and a second timer 18 that starts time measurement when the output terminal controller 16 changes the level of the output terminal 26 in the sleep mode, wherein the standby controller 14 performs recovering from the sleep mode of the CPU 13 when the second timer 18 performs a prescribed time measurement. According to the abovementioned configuration, it is possible to set timing that changes the level of the output terminal 26 by the first timer 17, and to set timing from changing the level of the output terminal 26 until recovering the CPU 13 from the sleep mode, by the second timer 18. Accordingly, even in a case where there is a deviation in timing of entering the sleep mode and timing of changing the level of the output terminal 26, since it is possible to fix timing from changing the level of the output terminal 26 until recovering the CPU 13 from the sleep mode, recovering from the sleep mode is not too early and there is no wasted power consumption.

Furthermore, a main clock controller 11 that supplies a main clock MC to the CPU 13 when the CPU 13 is in an operating state and stops the main clock MC when set to a sleep mode, and a subclock controller 15 that supplies a subclock SC to the first timer 17 and the second timer 18 are further provided. That is, even in a state where the main clock MC is stopped and instruction execution of the CPU 13 is stopped, the first timer 17 and the second timer 18 can perform time measurement by the subclock SC.

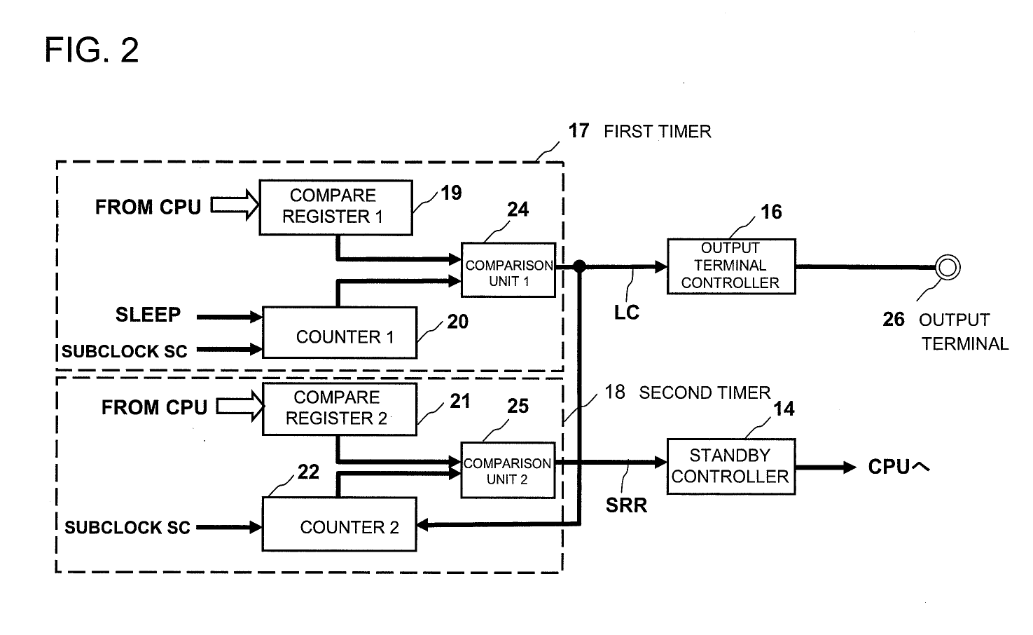

In sleep mode, the CPU 13 temporarily stops operation while holding internal data, and when recovering from the sleep mode is performed, operation is restarted from the temporarily stopped state, by the standby controller 14. Furthermore, as shown in FIG. 2, as an example, the first and the second timers (17 and 18) are each provided with counters (20 and 22) that count subclocks SC, compare registers (19 and 21) that can be set to an arbitrary value by an instruction of the CPU 13, and comparison units (24 and 25) that output match detection signals (LC and SRR) when values of the counters (20 and 22) and the compare registers (19 and 21) match. Furthermore, independent values can be set for the compare register 21 of the second timer 18 and the compare register 19 of the first timer 17.

When in the sleep mode, if the match detection signal LC of the first timer 17 is received, the output terminal controller 16 changes output voltage level of the output terminal 26, and the second timer 18 starts a count in the counter 22. Furthermore, in the sleep mode, the standby controller 14 receives the match detection signal SRR of the second timer 18 and recovers from the sleep mode.

Furthermore, a microcomputer system in one exemplary embodiment of the present invention, as shown in FIG. 1, for example, includes a microcomputer 10, and an external device 30 controlled by the microcomputer 10, with the microcomputer 10 and the external device 30 each being provided with a normal operation mode and a sleep mode in which power consumption is lower than in the normal operation mode, wherein the microcomputer 10 is provided with an output terminal 26 that controls mode (normal operation mode and sleep mode) of the external device 30, a first timer 17 that measures time for waking up the external device 30 when both of the microcomputer 10 and the external device 30 are in sleep mode, an output terminal controller 16 that, when the first timer 17 measures the wake-up time of the external device 30, changes level of the output terminal 26 to wake up the external device 30 while maintaining the sleep mode of the microcomputer 10, and a second timer 18 that, when the first timer 17 measures the time until the wake-up time of the external device 30, starts a count and measures the wake-up time of the microcomputer 10, and when the wake-up time of the microcomputer 10 comes, recovers the microcomputer 10 from the sleep mode and causes a return to the normal operation mode.

According to the abovementioned microcomputer system, even when the microcomputer 10 is in sleep mode, it is possible to wake up the external device 30 from sleep mode, by the first timer 17 and the output terminal controller 16. Furthermore, after waking up the external device 30, the microcomputer 10 itself can measure the time to wake up from sleep mode by the second timer 18. Since, by this type of configuration, since it is possible to reduce to the minimum required level the time to reach normal operation mode of the external device 30 and the microcomputer 10, it is possible to reduce the power consumption of the system.

Furthermore, in order that the microcomputer 10 and the external device 30 go into normal operation mode substantially at the same time, the second timer 18 measures time for recovering the microcomputer 10 from sleep mode. That is, time is required for recovery from sleep mode to normal operation mode for both the external device 30 and the microcomputer 10, and in a case where the wake-up time required for recovery from sleep mode to normal operation mode is larger for the external device 30, the external device 30 is woken up first, and giving consideration to the difference in times required to wake up the external device 30 and the microcomputer 10, by the second timer 18, it is possible to wake up the microcomputer 10 from sleep mode to normal operation mode at an optimum time.

Furthermore, the configuration is such that measured times of the first and the second timers (17 and 18) can each be set independently. Furthermore, the microcomputer 10 and the external device 30 may be formed on the same semiconductor substrate. A detailed description of examples are given below, making reference to the drawings.

### FIRST EXAMPLE

### Overall Configuration

FIG. 1 is a block diagram of an overall microcomputer system according to a first example. The microcomputer system of FIG. 1 is configured to include a microcomputer 10 and an external device 30 whose operation is controlled by the microcomputer 10.

First, a description is given concerning a configuration of the microcomputer 10. A CPU 13 controls operation of the overall microcomputer 10. A main clock controller 11 supplies a main clock MC, which is an operation clock of the CPU 13, to the CPU 13 and a peripheral circuit 12. Peripheral circuitry such as a DMA controller, a watchdog timer, an A/D converter, a D/A converter, a serial communications circuit, a memory, and the like, may be included in the peripheral circuit 12. The main clock controller 11 supplies a main clock MC to, among these, a circuit which the main clock MC requires.

A standby controller 14 performs control related to a low power consumption mode such as sleep mode or the like, in accordance with a control command given by the CPU 13. Here, the sleep mode is a mode in which supply of the main clock MC, being an operation clock signal, to the CPU 13, is stopped by stopping operation of the main clock controller 11, and the CPU 13 temporarily stops processing in a state in which data values and the like of an internal register are held. With regard to modes of the CPU 13, besides the sleep mode there is also a normal operation mode. In the normal operation mode, the CPU 13 operates and executes an instruction by the main clock MC supplied from the main clock controller 11. Furthermore, the standby controller 14, by a main clock control signal MCC, performs control so that the main clock controller 11 supplies a main clock MC to the CPU 13 when in the normal operation mode, and stops the supply of the main clock MC when in the sleep mode.

A subclock controller 15 generates a subclock SC when sleep mode has been entered and the main clock controller 11 stops the supply of the main clock MC to the CPU 13. The subclock SC may be a clock with a lower frequency than the main clock MC. Furthermore, an RC oscillator may be built-in, and a clock oscillated by the RC oscillator may be the subclock SC.

A first timer 17 and a second timer 18 are connected to the subclock SC outputted by the subclock controller 15, and perform an operation of counting the subclock SC. The standby controller 14 can start the first timer 17 when the CPU 13 is set to sleep mode, by a sleep mode signal SPEEP. Furthermore, a recovering from sleep mode request signal SRR is connected from the second timer 18 to the standby controller 14, and when in sleep mode, when a count value of the second timer 18 reaches a prescribed count number, it is possible to request recovering from the sleep mode. Moreover, when the first timer 17 reaches a prescribed count number, an output level change signal LC is outputted to an output terminal controller 16. The output terminal controller 16, when the output level change signal LC is received, in the sleep mode, changes the level of an output terminal 26. In the sleep mode, a configuration is possible in which programming is performed in advance as to how the level of the output terminal 26 changes when the output level change signal LC is received, and a setting can be made to a register or the like. Furthermore, the output level change signal LC is connected to the second timer 18, and when the first timer 17 outputs the output level change signal LC, in sleep mode, the second timer 18 receives this output level change signal LC and starts a count operation.

Similar to the microcomputer 10, the external device 30 is provided with at least a normal operation mode and a sleep mode. The normal operation mode is a mode in which operation of the external device 30 is executed, and the sleep mode is a mode in which power consumption is lower than the normal operation mode. The sleep mode of the external device 30 may be a mode in which a power supply of the external device 30 is shut off. Time required for a transition from the sleep mode to the normal operation mode, that is, wake-up time, may require a time such that the wake-up time of the external device 30 is longer than the wake-up time of the microcomputer 10.

The output terminal 26 of the microcomputer 10 is connected to the external device 30, and the microcomputer 10 can control switching the normal operation mode and the sleep mode of the external device 30 via the output terminal 26. The microcomputer 10 itself is set to the sleep mode by the first timer 17 and the output terminal controller 16, and even when the CPU 13 is temporarily stopped, the microcomputer 10 can execute switching of the normal operation mode and the sleep mode of the external device 30.

### [Configuration of Vicinity of Timer]

FIG. 2 is a block diagram of the timer vicinity in the microcomputer 10. In FIG. 2, the first timer 17 and the second timer 18 are connected in a cascade. The first timer 17 is provided with a counter 1 (20) that counts the subclock SC supplied from the subclock controller 15, a compare register 1 (19) that stores in advance a numerical value compared with a counted value of the counter 1 (20), and a comparison unit 1 (24) that compares the counted value of the counter 1 (20) and a numerical value of the compare register 1 (19).

The counter 1 (20) is connected to a sleep mode signal SLEEP supplied from the standby controller 14, and when the sleep mode signal SLEEP becomes active, starts counting the subclock SC. Furthermore, the compare register 1 (19) may be able to set a prescribed numerical value to a register by the CPU 13 as shown in FIG. 2. When the counted value of the counter 1 (20) matches a numerical value stored in advance in the compare register 1 (19), the comparison unit 1 (24) makes the output level change signal LC active. The output level change signal LC is connected to the output terminal controller 16 and a counter 2 (22) of the second timer 18. When the output level change signal LC becomes active, the output terminal controller 16 changes voltage level of the output terminal 26.

The second timer 18 is provided with the counter 2 (22) that counts the subclock SC supplied from the subclock controller 15, a compare register 2 (21) that stores in advance a numerical value compared with a counted value of the counter 2 (22), and a comparison unit 2 (25) that compares the counted value of the counter 2 (22) and a numerical value of the compare register 2 (21). The counter 2 (22) is connected to an output level change signal LC supplied from the comparison unit 1 (24) of the first timer 17, and when the output level change signal LC becomes active, starts counting the subclock SC. Furthermore, the compare register 2 (21) may be able to set a prescribed numerical value by the CPU 13 similar to the compare register 1 (19). When the counted value of the counter 2 (22) matches a numerical value of the compare register 2 (21), the comparison unit 2 (25) makes the recovering from sleep mode request signal SRR active. The recovering from sleep mode request signal SRR is connected to the standby controller 14, and when the standby controller 14 receives the recovering from sleep mode request signal SRR, in the sleep mode, it makes a transit from the sleep mode to the normal operation mode.

By the abovementioned configuration, when the microcomputer 10 and the external device 30 connected to outside the microcomputer 10 are both in sleep mode, after firstly waking up the external device 30 by the first timer 17, the CPU 13 can be woken up by the second timer 18.

### [Operation of First Example]

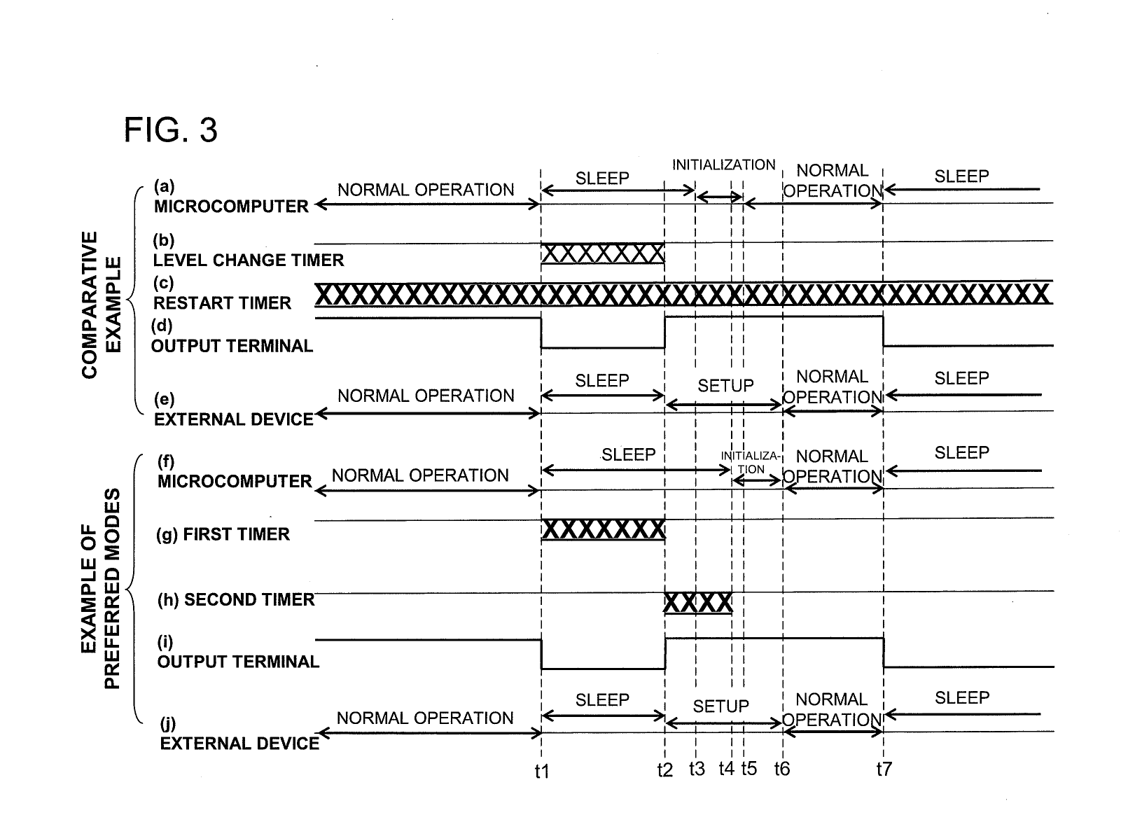

FIG. 3 is a timing diagram showing operation of the microcomputer system of the first example of preferred mode. For comparison, a timing diagram of a comparative example based on Patent Document 1 is also shown. First, after giving a description concerning operation timing (FIG. 3, (f) to (j)) of the first example, differences in operation from conventional technology are described.

In FIG. 3, (f) to (j), which describe operation of the first example, up to timing t1 both the microcomputer 10 and the external device 30 are in the normal operation mode. At this time, the microcomputer 10 and the external device 30 each execute prescribed processing. The first timer 17 and the second timer 18 are both stopped (refer to FIG. 3, (g) and (h)). In the normal operation mode, neither the first timer 17 nor the second timer 18 have to operate in order to control the sleep mode, but may operate for other purposes. However, at least before timing t1, it is necessary to reset the counter 1 (20) and the counter 2 (22), and to set a prescribed value to the compare register 1 (19) and the compare register 2 (21).

Here, a description is given concerning prescribed values set in the compare register 1 (19) and the compare register 2 (21). Frequency of the subclock SC, setup time from the sleep mode of the external device 30 to the normal operation mode, and, after entering the sleep mode, a value giving consideration to time required by a subsequent normal operation are set in the compare register 1 (19). That is, the value is set so that, after entering the sleep mode, the setup of the external device 30 is completed by the time required by the subsequent normal operation. Furthermore, a value equivalent to the difference between the time required for the setup of the external device 30 and the time after waking up the microcomputer 10 from the sleep mode until a transition can be performed to normal operation, is set in the compare register 2 (21). That is, since the wake-up time required for the transition from the sleep mode to normal operation mode is longer for the external device 30 than the microcomputer 10, a value for the difference between the these wake-up times is set in the compare register 2 (21), giving consideration to the frequency of the subclock.

The description is continued, returning to FIG. 3. Here, with both the first timer 17 and the second timer 18 stopped in the normal operation mode, both the counter 1 (20) and the counter 2 (22) are reset, and prescribed numerical values are stored in advance in the compare register 1 (19) and the compare register 2 (21). Furthermore, the output terminal controller 16 of the microcomputer 10 outputs at a high level to the output terminal 26.

At timing t1, since both the microcomputer 10 and the external device 30 have completed execution of prescribed processing, in order to reduce power consumption, there is a transition to sleep mode (refer to FIG. 3, (f) and (j)). The transition to the sleep mode is performed by transitioning the standby controller 14 to the sleep mode by an instruction of the CPU 13 of the microcomputer 10. At this time, the output terminal controller 16 of the microcomputer 10 drops a voltage level of the output terminal 26 from a high level to a low level (refer to FIG. 3, (i)). Thereupon, the external device 30 switches from normal operation mode to the sleep mode. The standby controller 14 of the microcomputer 10 makes the sleep mode signal SLEEP active at the same time as the sleep mode is entered. Thereupon, the first timer 17 starts a count of the subclock SC (refer to FIG. 3, (g)). At this time, the second timer 18 is stopped (refer to FIG. 3, (h)).

At timing t2, the comparison unit 1 (24) of the first timer 17 detects a match, and the output level change signal LC becomes active. Thereupon, the output terminal controller 16 raises the output terminal 26 from a low level to a high level (refer to FIG. 3, (i)). Thereupon, the external device 30 starts the setup (refer to FIG. 3, (j)). Furthermore, the counter 2 (22) of the second timer 18, on receiving information that the output level change signal LC has become active, starts a count (refer to FIG. 3, (h)). Furthermore, the first timer 17 completes the count and returns to an initial state (refer to FIG. 3, (g)).

At timing t4, the comparison unit 2 (25) of the second timer 18 detects a match, and the recovering from sleep mode request signal SRR becomes active. Thereupon, the standby controller 14 makes the main clock control signal MCC active, supplies the main clock MC from a main clock controller 11 to the CPU 13, and wakes up the CPU 13. The CPU 13, after recovering form sleep mode, executes processing (initialization processing and the like) required until normal operation is started (refer to FIG. 3, (f)). The second timer 18 completes the count and returns to an initial state (refer to FIG. 3, (h)).

At timing t6, the wake-up operation of the microcomputer 10 and the wake-up operation of the external device 30 are completed at approximately the same time. Therefore, the microcomputer 10 and the external device 30 both transition to the normal operation mode. After timing t7, processing after timing t1 is repeated.

[Difference from Operation of Comparative Example]

If operations of the abovementioned example of preferred modes (FIG. 3, (f) to (j)) and operations of the comparative example based on Patent Document 1 (FIG. 3, (a) to (e)) are compared, with regard to the comparative example in which wake-up control of the external device is performed based on a level change timer, equivalent to the first timer 17 in the first example of preferred modes, the wake-up control of the microcomputer of the comparative example is performed based on a restart timer that is asynchronous with the level change timer. Therefore, there are cases where the wake-up time of the microcomputer is too early, according to timing of entering sleep mode. For example, in FIG. 3, (a), considering that it is preferable to enter the normal operation mode at the same time as the external device, the time at which the microcomputer enters normal operation mode may be at timing t6. As a result, irrespective of the fact that waking up is preferably done at timing t4, waking up is done at timing t3 by the restart timer. Therefore, the normal operation mode is entered from timing t5. That is, the microcomputer of the comparative example consumes unnecessary power from timing t5 to timing t6.

According to the abovementioned example, a value set in the compare register 1 (19) of the first timer 17 and a value set in the compare register 2 (21) of the second timer 18 can each be set independently, and even if the value set in one of either of the compare registers is changed, there is no need to change the value set in the other compare register. This is because, when the first timer 17 detects a match and the level of the output terminal changes, the second timer 18 starts a count, there is no effect on the count of the second timer 18 due to the timing at which the first timer 17 detects the match.

Therefore, the time after setting sleep mode until the external device 30 is woken up may be set in the compare register 1 (19), and the difference between time required for wake-up of the external device 30 and time required for wake-up of the microcomputer 10 may be set in the compare register 2 (21). For example, if wake-up processing of the external device 30 is only increasing a simple power supply, this is always a constant time. According to a state of the overall system, in a case where it is necessary to change the time required from setting the external device 30 to sleep mode until wake-up, the value of the compare register 1 (19) only may be changed, and there is no necessity to change the value of the compare register 2 (21). On the other hand, according to a state of the microcomputer 10, in a case where there is a change of the time required for processing such as initialization from the sleep mode of the microcomputer 10 until transition to the normal operation mode, the value of the compare register 2 (21) only may be changed, and there is no necessity to change the value of the compare register 1 (19).

When the microcomputer 10 is in sleep mode, at least the subclock controller 15, the first timer 17, the second timer 18, and the output terminal controller 16 must be capable of operating, but the external device 30 does not have such a limitation. The sleep mode of the external device 30 may be a mode in which a power supply is simply shut off. Specification of the sleep mode of the external device 30 can be arbitrarily decided according to system needs.

Furthermore, in the abovementioned example a description has been given mainly concerning an example in which the external device 30 is a separate device from the microcomputer 10, but the external device 30 may be a peripheral circuit formed on the same semiconductor substrate as the microcomputer 10. In such a case, the output terminal 26 is an output terminal in a chip that controls the peripheral circuit (external device 30) from the microcomputer 10 side in the same chip.

Furthermore, in the abovementioned example, since the first timer 17 and the second timer 18 do not operate at the same time, the counter 1 (20) and the counter 2 (22), and the comparison unit 1 (24) and the comparison unit 2 (25) may have a shared circuit. However, it is necessary that the compare register 1 (19) and the compare register 2 (21) be provided separately and that functions of the first timer 17 and the second timer 18 be implemented.

In the present disclosure, various modes are possible which includes the following, but not restrictive thereto.

(Mode 1): A microcomputer as set forth as the first aspect.
(Mode 2): In the microcomputer according to mode 1, further comprising:

a main clock controller that supplies a main clock to said CPU when said CPU is in an operating state, and stops said main clock when set to said sleep mode; and

a subclock controller that supplies a subclock to said first timer and said second timer.

(Mode 3): In the microcomputer according to mode 1 or 2, wherein,

in said sleep mode, said CPU temporarily stops operation while holding internal data, and when recovering from said sleep mode is performed, by said standby controller, operation is restarted from said temporarily stopped state.

(Mode 4): In the microcomputer according to mode 2, wherein

each of said first and second timers comprises:

a counter that counts said subclock;

a compare register that can be set to an arbitrary value by an instruction of said CPU; and

a comparison unit that outputs a match detection signal when values of said counter and said compare register match.

(Mode 5): In the microcomputer according to mode 4, wherein a value that is independent of said compare register of said first timer can be set in said compare register of said second timer.
(Mode 6): In the microcomputer according to mode 4 or 5, wherein

when a match detection signal of said first timer is received when in said sleep mode,

said output terminal controller changes output voltage level of said output terminal, and

said second timer starts a count by said counter.

(Mode 7): In the microcomputer according to any one of modes 4 to 6, wherein, in said sleep mode, said standby controller receives a match detection signal of said second timer and performs recovering from said sleep mode.
(Mode 8): A microcomputer system as set forth as the second aspect.
(Mode 9): In the microcomputer system according to mode 8, wherein said second timer measures time for recovering from sleep mode of said microcomputer so that said microcomputer and said external device enter normal operation mode substantially at the same time.
(Mode 10): In the microcomputer system according to mode 8 or 9, wherein measurement times of said first and second timers are configured so that each can be set independently.
(Mode 11): In the microcomputer system according to any one of modes 8 to 10, wherein said microcomputer and said external device are formed on the same semiconductor substrate.

A description has been given above concerning the exemplary embodiment, but the present invention is not limited to only a configuration of the abovementioned exemplary embodiment, and clearly includes every type of transformation and modification that a person skilled in the art can realize within the scope of the claims of the invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A microcomputer comprising:
a CPU;
a standby controller that controls setting of and recovering from sleep mode of said CPU;
an output terminal;
a first timer;
an output terminal controller that, when said first timer performs predetermined time measurement when said CPU is in said sleep mode, changes level of said output terminal while maintaining said sleep mode; and
a second timer that starts time measurement when said output terminal controller changes the level of said output terminal in said sleep mode; wherein
said standby controller performs recovering from said sleep mode of said CPU when said second timer performs a prescribed time measurement.

2. The microcomputer according to claim 1, further comprising:
a main clock controller that supplies a main clock to said CPU when said CPU is in an operating state, and stops said main clock when set to said sleep mode; and
a subclock controller that supplies a subclock to said first timer and said second timer.

3. The microcomputer according to claim 1, wherein,
in said sleep mode, said CPU temporarily stops operation while holding internal data, and when recovering from said sleep mode is performed, by said standby controller, operation is restarted from said temporarily stopped state.

4. The microcomputer according to claim 2, wherein
each of said first and second timers comprises:
a counter that counts said subclock;
a compare register that can be set to an arbitrary value by an instruction of said CPU; and
a comparison unit that outputs a match detection signal when values of said counter and said compare register match.

5. The microcomputer according to claim 4, wherein a value that is independent of said compare register of said first timer can be set in said compare register of said second timer.

6. The microcomputer according to claim 4, wherein
when a match detection signal of said first timer is received when in said sleep mode,
said output terminal controller changes output voltage level of said output terminal, and
said second timer starts a count by said counter.

7. The microcomputer according to claim 4, wherein, in said sleep mode, said standby controller receives a match detection signal of said second timer and performs recovering from said sleep mode.

8. A microcomputer system comprising a microcomputer and an external device controlled by said microcomputer, said microcomputer and said external device each having a normal operation mode and a sleep mode with lower power consumption than said normal operation mode, wherein
said microcomputer comprises:
an output terminal that controls said modes of said external device;
a first timer that, when both of said microcomputer and said external device are in said sleep mode, measures time to wake up said external device;
an output terminal controller that, when said first timer has measured said wake-up time of said external device, changes level of said output terminal and wakes up said external device, while maintaining said sleep mode of said microcomputer; and
a second timer that, when said first timer measures time for wake-up of said external device, starts a count, measures wake-up time of said microcomputer, and when said wake-up time of said microcomputer has come, performs recovering said microcomputer from said sleep mode to return to said normal operation mode.

9. The microcomputer system according to claim 8, wherein said second timer measures time for recovering from sleep mode of said microcomputer so that said microcomputer and said external device enter normal operation mode substantially at the same time.

10. The microcomputer system according to claim 8, wherein measurement times of said first and second timers are configured so that each can be set independently.

11. The microcomputer system according to claim 8, wherein said microcomputer and said external device are formed on the same semiconductor substrate.
